(19) United States
(12) Patent Application Publication
(10) Pub. No.: US 2009/0191023 A1
(43) Pub. Date: Jul. 30, 2009

(54) NAIL STRIP OF U-SHAPED NAILS

(76) Inventor: HSUEH-PIN CHANG, Ta Ya Hsiang (TW)

Correspondence Address: LEONG C LEI, PMB # 1008, 1867 YGNACIO VALLEY ROAD, WALNUT CREEK, CA, 94598, US

(21) Appl. No.: 12/020,583

(22) Filed: Jan. 28, 2008

(51) Int. Cl. F16B 15/08

(52) U.S. Cl. 411/443; 411/442

(57) ABSTRACT

A nail strip is composed of a plurality of U-shaped nails or staples lined up along a line-up axis and bonded to each other in a side-by-side and detachable manner. Each staple includes a crown and two legs extending from opposite ends of the crown. The staples are oriented to have the crowns forming a serration configuration and the legs inclined with respect to the line-up axis so that when the staples are applied to a work piece the legs of the staples are forced into the work piece by following the inclination thereof to allow the staples to be applied to an edge of a work piece in a corner thereby enhancing the bonding force of the work piece at the edge.

### BACKGROUND OF THE INVENTION

(a) Technical Field of the Invention

The present invention relates to a nail strip, and in particular to a nail strip composed of lined-up nails or staples that are inclined with respect to a line-up axis in order to allow legs of the nails or staples to be struck in an inclined manner into an edge or corner of a work piece to enhance fastening result effected by the nails or staples.

(b) Description of the Prior Art

A conventional nail strip for U-shaped nails or staples is illustrated in FIGS. 1 and 2 of the attached drawings, and FIG. 3 shows nailing operation of the nail strip with a nailer. The conventional nail strip is composed of a plurality of nails or staples 10, which are lined up along a line-up axis and is successively attached to each other side by side. Each nail 10 has a crown 11 and two legs 12 that are integrally formed on and extends from opposite ends of the crown 11. The conventional nail strip suffers a disadvantage in that when the nail 10 is operated by a nailer 20 to forcibly penetrate into a work piece 13, since the nail 10 is maintained in a normal erected condition in the strip, the nail 10 can only be struck into the work piece 13 in a direction substantially perpendicular to the line-up axis. This prevents the nail 10 from being effectively struck into an edge or a corner of the work piece 13 as most clearly shown in FIG. 3. Consequently, the work piece 13 that is to be fixed by nails may suffer insufficiency of fastening force at the edge for no nail can be applied there.

It is desired to provide a nail strip that overcomes the above drawbacks.

### SUMMARY OF THE INVENTION

The primary purpose of the present invention is to provide an improved nail strip for U-shaped nails or staples, which is composed of a plurality of U-shaped nails or staples that is lined up along a line-up axis and bonded together. Each staple comprises a crown and two legs extending from opposite ends of the crown. The staples are oriented in such a way that the crowns form a serration configuration in a side elevational view and the legs are inclined with respect to the line-up axis. Thus, when the staple is driven by a nailer to penetrate into a work piece, the legs are forced into the work piece by following the inclination thereof so that the staple can be applied to a corner to enhance the bonding force or fastening force of the work piece at the corner.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of a conventional nail strip;

FIG. 2 is a side elevational view of the conventional nail strip;

FIG. 3 is a schematic side elevational view demonstrating the insufficiency of space in applying the conventional nail strip to an edge of a work piece at a corner by a nailer;

FIG. 4 is a perspective view of a nail strip constructed in accordance with the present invention;

FIG. 5 is a side elevational view of the nail strip of the present invention;

FIG. 6 is schematic side elevational view illustrating application of the nail strip of the present invention to an edge of a work piece at a corner by a nailer;

FIG. 7 is a perspective view illustrating a nail strip constructed in accordance with another embodiment of the present invention; and

FIG. 8 is a side elevational view of the nail strip of said another embodiment of the present invention.

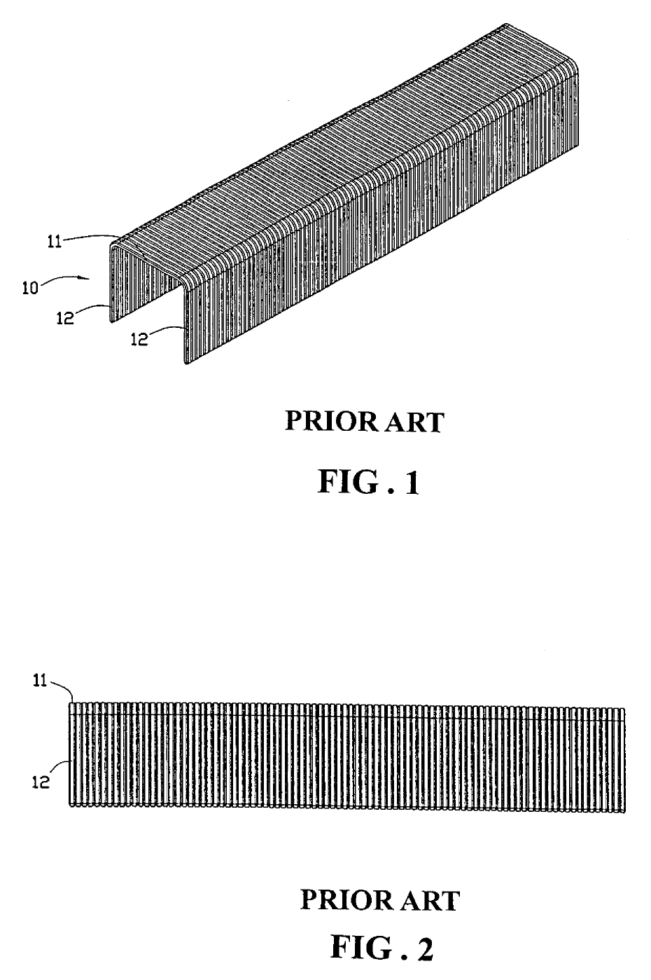

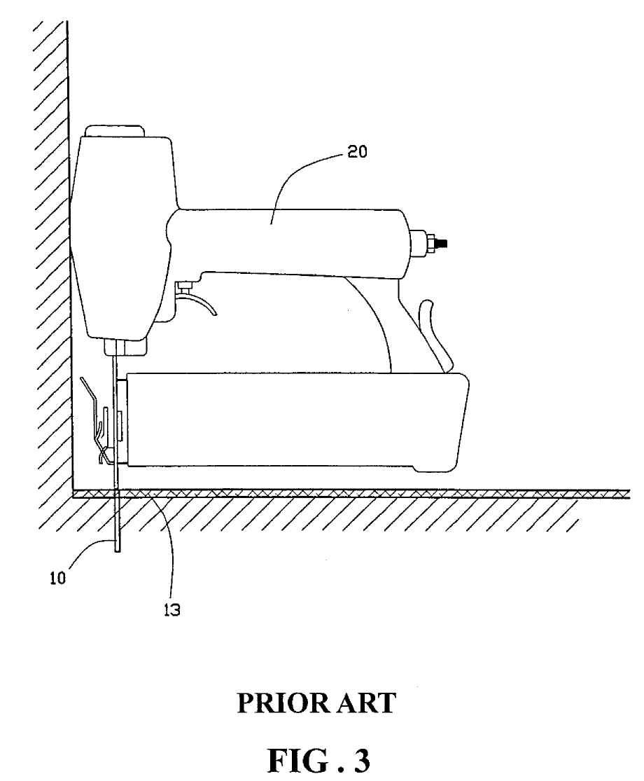

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

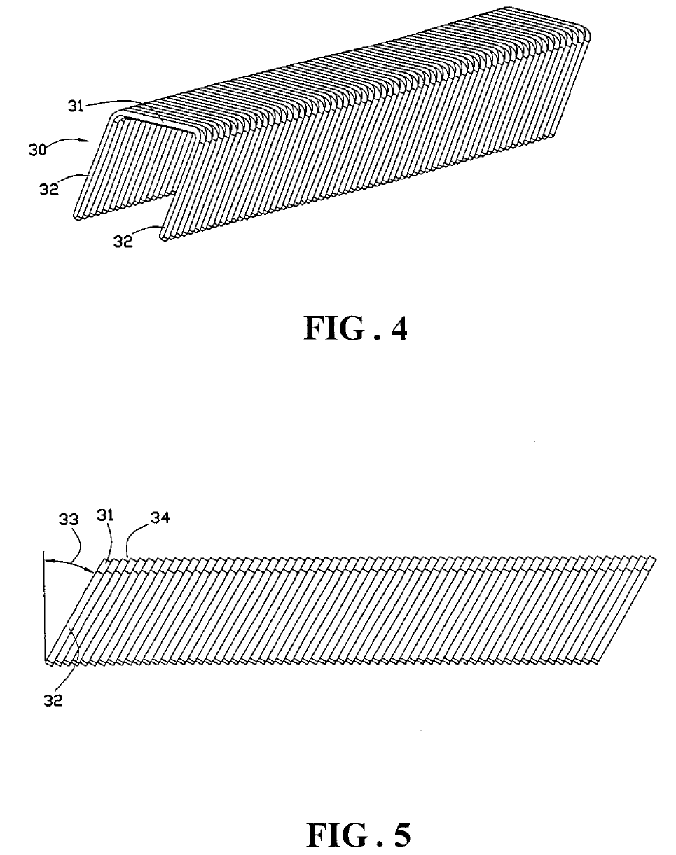

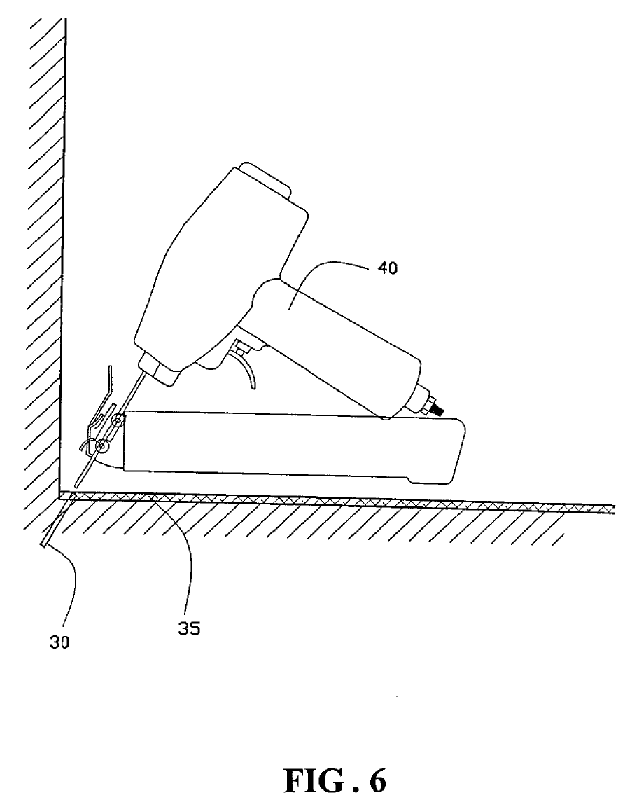

With reference to the drawings and in particular to FIGS. 4-6, a nail strip constructed in accordance with the present invention comprises a plurality of nails or staples 30, each having a crown 31 and two legs 32 integrally extending from opposite ends of the crown 31.

The staples 30 are lined up along a line-up axis in a side by side manner and are bonded together but can be sheared off each other. The staples 30 are oriented so that the legs 32 of the stapes 30 are inclined with respect to the line-up axis and an included angle 33 is formed between the legs 32 and an imaginative line that is perpendicular to the line-up axis and the crowns 31 as viewed in the side view form a serration configuration 34. Thus, the nail strip 30 is applied to a work piece 35, the legs 32 of the staple 30 can be forced into the work piece 35 by following the inclination thereof and application of the nails 30 to an edge of the work piece 30 at a corner by a nailer 40 can thus be realized, and the bonding force of the work piece 30 at the edge can be enhanced.

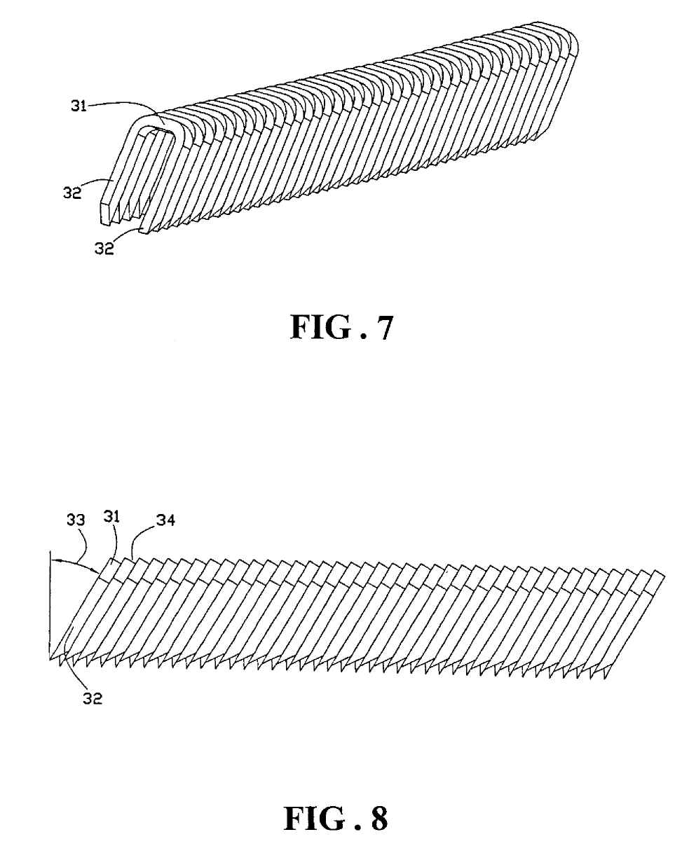

FIGS. 7 and 8 show a different embodiment of the nail strip in accordance with the present invention, which is substantially identical to the embodiment shown in FIGS. 4 and 5, except that the nail 31 that constitutes the nail strip 30 of said different embodiment have legs 32 that has sharpened tips defined by inclined faces in opposite directions.

Although the present invention has been described with reference to the preferred embodiments thereof, it is apparent to those skilled in the art that a variety of modifications and changes may be made without departing from the scope of the present invention which is intended to be defined by the appended claims.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A nail strip comprising a plurality of nails lined up in a given direction and bonded to each other in a side-by-side and detachable manner, each nail comprising a crown and two legs extending from opposite ends of the crown, wherein the nails are oriented to have the crowns forming a serration configuration and the legs inclined with respect to the given direction so that when the nails are applied to a work piece the legs of the nails are forced into the work piece by following the inclination thereof.
